(19) United States
(12) Patent Application Publication
(10) Pub. No.: US 2024/0270632 A1
(43) Pub. Date: Aug. 15, 2024

(54) WINDOW MANUFACTURING METHOD AND DISPLAY DEVICE

(71) Applicant: Samsung Display Co., Ltd., Yongin-Si (KR)

(72) Inventors: JONGHYEON CHOI, Yongin-si (KR); GWANGTEAK LEE, Yongin-si (KR)

(21) Appl. No.: 18/414,489

(22) Filed: Jan. 17, 2024

(30) Foreign Application Priority Data
Feb. 10, 2023 (KR) 10-2023-0017799

(51) Int. Cl. C03C 17/32

(52) U.S. Cl. CPC C03C 17/32; C03C 2217/40

(57) ABSTRACT

Provided is a window manufacturing method including providing a pattern glass having a first non-pattern part, a pattern part, and a second non-pattern part which are arranged in a first direction, forming a first part and a second part by providing a first resin onto a first surface of the first non-pattern part and a first surface of the second non-pattern part, forming first filling patterns by providing second resins to first grooves defined on a first surface of the pattern part, and forming a first pattern layer by providing a third resin onto the first surface of the pattern part to cover the first filling patterns, and the first filling patterns may be spaced apart from each other in the first direction.

### CROSS-REFERENCE TO RELATED APPLICATIONS

This U.S. non-provisional patent application claims priority under 35 U.S.C. § 119 of Korean Patent Application No. 10-2023-0017799, filed on Feb. 10, 2023, the entire contents of which are hereby incorporated by reference.

### BACKGROUND

The present disclosure herein relates to a window manufacturing method and a display device including a window manufactured using the window manufacturing method.

An electronic device displays various images on a display screen to provide information to a user. In general, the electronic device displays information within an assigned screen. Recently, a flexible electronic device including a flexible display panel capable of folding is being developed. The flexible electronic device, unlike a rigid electronic device, may be foldable, rollable, or bendable. The flexible electronic device, which is variously deformable, is easily portable regardless of the existing screen size, thus improving the user convenience.

The electronic device includes a display panel, and a window disposed on the display panel to protect the display panel. The window may have a plurality of patterns defined therein in order to secure flexibility of the flexible electronic device.

### SUMMARY

The present disclosure provides a method for manufacturing a window including a pattern part invisible to a user and having improved surface quality, and provides a display device including a window manufactured using the method.

An embodiment of the inventive concept provides a window manufacturing method including providing a pattern glass including a first non-pattern part, a pattern part, and a second non-pattern part which are arranged in a first direction. A first part and a second part are formed by providing a first resin onto a first surface of the first non-pattern part and a first surface of the second non-pattern part. First filling patterns are formed by providing second resins to first grooves defined on a first surface of the pattern part. A first pattern layer is formed by providing a third resin onto the first surface of the pattern part to cover the first filling patterns, and the first filling patterns may be spaced apart from each other in the first direction.

In an embodiment of the inventive concept, a display device includes a display panel, and a pattern glass disposed on the display panel. The pattern glass includes a first non-pattern part, a pattern part, and a second non-pattern part which are arranged in a first direction. First filling patterns are disposed in first grooves defined on a first surface of the pattern part. A first part is disposed on a first surface of the first non-pattern part, a second part is disposed on a first surface of the second non-pattern part, and a first pattern layer is disposed between the first part and the second part, and covers the first filling patterns. Outer surfaces of the first filling patterns may protrude from a first surface of the pattern glass.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept.

FIG. 1 is a perspective view of an electronic device according to an embodiment of the inventive concept.

FIG. 2 is a perspective view illustrating a folded state of the electronic device illustrated in FIG. 1.

FIG. 3 is an exploded perspective view of an electronic device according to an embodiment of the inventive concept.

FIG. 4 is a cross-sectional view taken along line I-I′ of FIG. 3.

FIG. 5 is a cross-section view of a display panel illustrated in FIG. 3.

FIG. 6 is a plan view of a display module including the display panel illustrated in FIG. 5.

FIG. 7 is an enlarged view of a first region A1 of FIG. 4.

FIG. 8 is a plan view of a pattern glass illustrated in FIG. 7.

FIG. 9 is a cross-sectional view taken along line II-II′ of FIG. 8.

FIG. 10 is a cross-sectional view of a pattern glass having a resin disposed therein.

FIGS. 11A, 11B, 11C, 11D, 11E, 11F, 11G, 11H, 11I, 11J, 11K, and 11L are views illustrating a window manufacturing method according to an embodiment of the inventive concept.

FIG. 12 is a perspective view of an upper resin layer and a lower resin layer manufactured according to the method illustrated in FIGS. 11A through 11L.

### DETAILED DESCRIPTION

Features of the inventive concept and methods for achieving them will become apparent with reference to the embodiments described below in detail with the accompanying drawings. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art. The inventive concept is only defined by the scope of the claims. Like reference numerals or symbols refer to like elements throughout the specification.

It will be understood that when an element or layer is referred to as being “on” another element or layer, it can be directly on the other element or layer or another element or layer may be interposed therebetween. In contrast, when an element is referred to as being “directly on” another element or layer, there are no intervening elements or layers present. As used herein, the term “and/or” includes any and all combinations of one or more of the associated listed items.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. Like reference numerals or symbols refer to like elements throughout the specification.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Embodiments described herein will be described with reference to plan and cross-sectional views, which are ideal schematic diagrams of the inventive concept. Therefore, the form of the exemplary diagram may be modified due to manufacturing techniques and/or tolerances. Accordingly, the embodiments of the inventive concept are not limited to the specific forms illustrated herein, but also include changes in form generated according to the manufacturing process. Therefore, regions illustrated in the drawings have general properties, and the shapes of the regions illustrated in the drawing are to illustrate specific shapes of the regions of elements, but are not intended to limit the scope of the inventive concept.

Hereinafter, embodiments of the inventive concept will be described in detail with reference to the accompanying drawings.

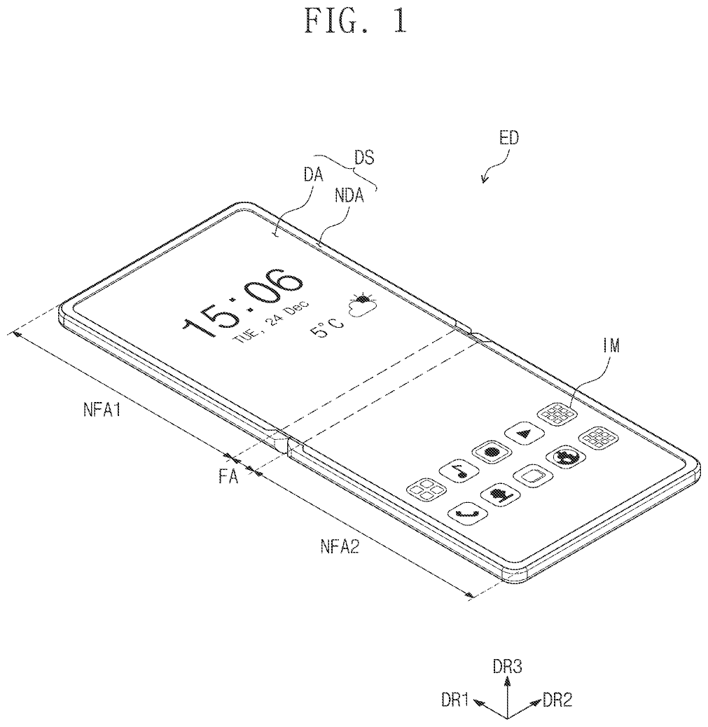

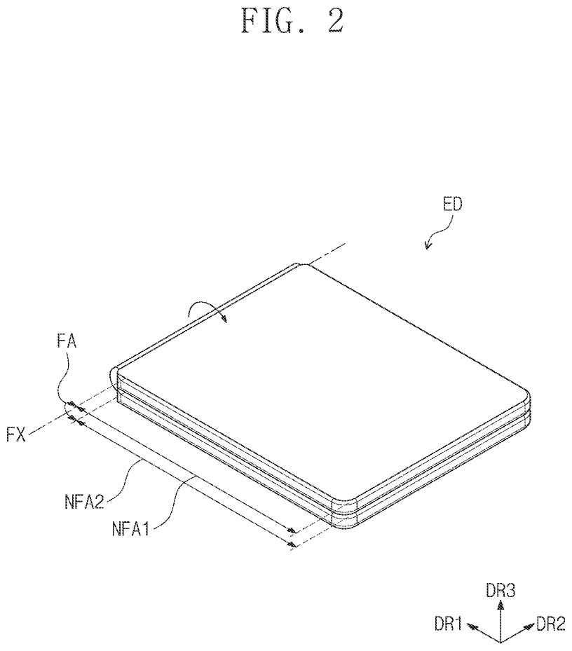

FIG. 1 is a perspective view of an electronic device ED according to an embodiment of the inventive concept. FIG. 2 is a perspective view illustrating a folded state of the electronic device ED illustrated in FIG. 1.

Referring to FIG. 1, the electronic device ED according to an embodiment of the inventive concept may have a rectangular shape having long sides extending in a first direction DR1 and short sides extending in a second direction DR2 crossing the first direction DR1. However, an embodiment of the inventive concept is not limited thereto, and the electronic device ED may have various shapes such as circular and polygonal shapes. The electronic device ED may be a flexible electronic device.

Hereinafter, a direction substantially perpendicular to a plane defined by the first direction DR1 and the second direction DR2 is defined as a third direction DR3. In addition, in this specification, “when viewed on a plane” may be defined as a state of being viewed from the third direction DR3. In addition, in this specification, the meaning of “overlapping” may indicate a state in which components, when viewed on a plane, are disposed overlapping each other.

The electronic device ED may include a folding region FA and a plurality of non-folding regions NFA1 and NFA2. The non-folding regions NFA1 and NFA2 may include a first non-folding region NFA1 and a second non-folding region NFA2. The folding region FA may be disposed between the first non-folding region NFA1 and the second non-folding region NFA2. The first non-folding region NFA1, the folding region FA, and the second non-folding region NFA2 may be arranged in the first direction DR1.

One folding region FA and two non-folding regions NFA1 and NFA2 are exemplarily illustrated, but the numbers of the folding region FA and the non-folding regions NFA1 and NFA2 are not limited thereto. For example, the electronic device ED may include at least three non-folding regions and a plurality of folding regions disposed between the non-folding regions.

An upper, e.g., first, surface of the electronic device ED may be defined as a display surface DS, and may have a flat surface defined by the first direction DR1 and the second direction DR2. Images IM generated in the electronic device ED may be provided to a user through the display surface DS.

The display surface DS may include a display region DA and a non-display region NDA around the display region DA. The display region DA may display an image, and the non-display region NDA may not display an image. The non-display region NDA may surround the display region DA, and define the border, printed in a predetermined color, of the electronic device ED.

Although not illustrated in the drawing, the electronic device ED may include a plurality of sensors and at least one camera.

Referring to FIG. 2, the electronic device ED may be a foldable electronic device ED that is folded or unfolded. For example, the electronic device ED may be folded such that the folding region FA is bent with respect to a folding axis FX parallel to the second direction DR2. The folding axis FX may be defined as a short axis parallel to the short side of the electronic device ED.

When the electronic device ED is folded, the electronic device ED may be in-folded such that the first non-folding region NFA1 and the second non-folding region NFA2 face each other and the display surface DS is not exposed to the outside. However, an embodiment of the inventive concept is not limited thereto. For example, the electronic device ED may be out-folded with respect to the folding axis FX such that the display surface DS is exposed to the outside.

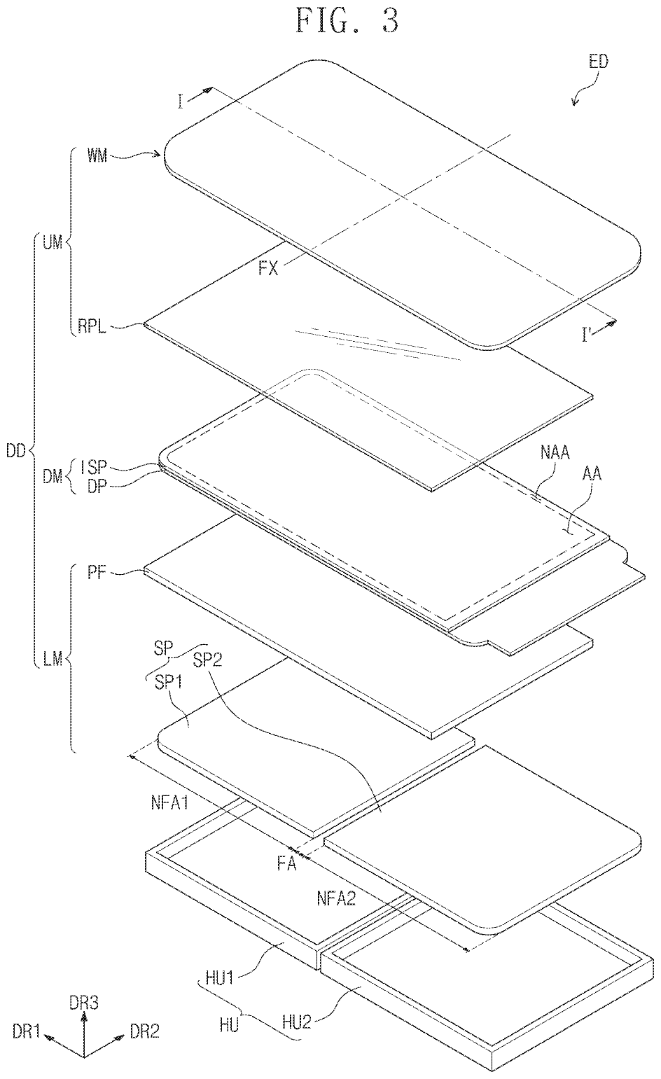

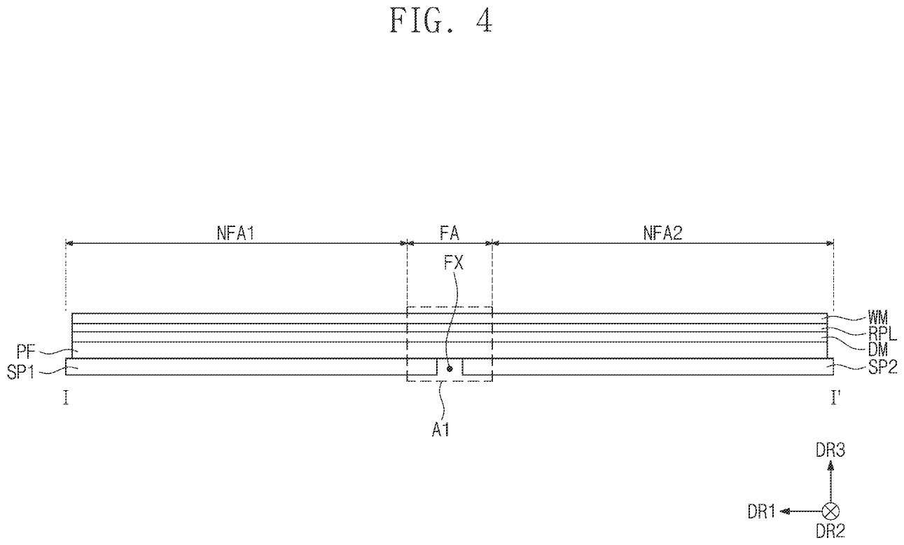

FIG. 3 is an exploded perspective view of an electronic device ED according to an embodiment of the inventive concept. FIG. 4 is a cross-sectional view taken along line I-I′ of FIG. 3.

Referring to FIGS. 3 and 4, the electronic device ED may include a display device DD and a housing HU. Although not illustrated in the drawing, the electronic device ED may further include a mechanism structure for controlling a folding operation of the display device DD.

The display device DD according to an embodiment of the inventive concept may include a display module DM which displays an image, an upper module UM disposed on the display module DM, and a lower module LM disposed under the display module DM. The display module DM may constitute a portion of the display device DD, and particularly, an image may be generated by the display module DM. The display module DM may display the image in response to electrical signals, and transmit/receive information on an external input. The display module DM may have an active region AA and a peripheral region NAA defined therein. The active region AA may be defined as a region in which the image provided from the display module DM is emitted.

The peripheral region NAA may be adjacent to the active region AA. For example, the peripheral region NAA may surround the active region AA. However, this is an example, and the peripheral region NAA may be defined as various shapes, and is not limited to any one embodiment. According to an embodiment, the active region AA of the display module DM may overlap at least a portion of the display region DA of FIG. 1.

The display module DM may include a display panel DP and an input-sensing unit ISP. The display panel DP according to an embodiment of the inventive concept may be an emission-type display panel, and is not particularly limited. For example, the display panel DP may be an organic light-emitting display panel, an inorganic light-emitting display panel, or a quantum-dot light-emitting display panel. A light-emitting layer of the organic light-emitting display panel may include an organic light-emitting material, and a light-emitting layer of the inorganic light-emitting display panel may include an inorganic light-emitting material. A light-emitting layer of the quantum-dot light-emitting display panel may include quantum dots, quantum rods, and the like. Hereinafter, the display panel DP will be described as the organic light-emitting display panel.

The display panel DP may be a flexible display panel. Accordingly, the display panel DP may be entirely rolled, or folded or unfolded with respect to a folding axis FX.

The input-sensing unit ISP may be directly disposed on the display panel DP. According to an embodiment of the inventive concept, the input-sensing unit ISP may be formed on the display panel DP through a continuous process. That is, when the input-sensing unit ISP is directly disposed on the display panel DP, an adhesive film is not disposed between the input-sensing unit ISP and the display panel DP. However, an embodiment of the inventive concept is not limited thereto. In an embodiment, an adhesive film may be disposed between the input-sensing unit ISP and the display panel DP. In this case, the input-sensing unit ISP may not be manufactured through a continuous process together with the display panel DP, but may be manufactured through a separate process from the display panel DP, and then fixed on an upper surface of the display panel DP by the adhesive film.

The display panel DP generates an image, and the input-sensing unit ISP acquires coordinate information on a user's input, for example, a touch event.

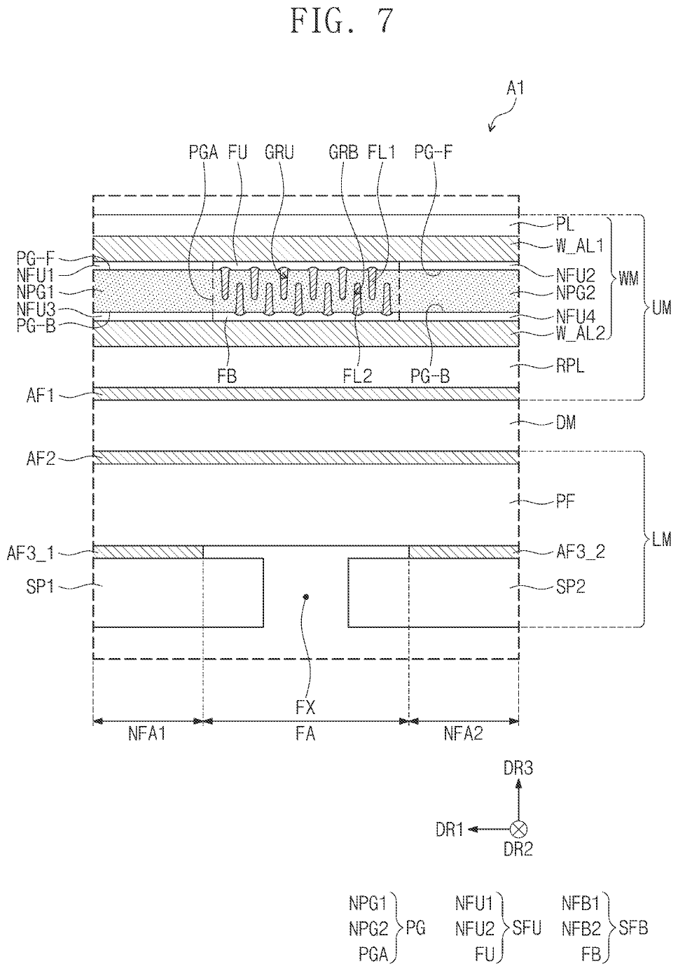

The upper module UM may include a window WM disposed on the display module DM. The window WM may include an optically transparent insulation material. Accordingly, the image generated from the display module DM may pass through the window WM, and may be easily viewed to a user. The window WM will be described in detail with reference to FIG. 7.

The upper module UM may further include at least one functional layer disposed between the display module DM and the window WM. According to an embodiment of the inventive concept, the functional layer may be an anti-reflection layer RPL for blocking external light reflection.

The anti-reflection layer RPL may prevent elements constituting the display module DM from being visible from the outside due to external light incident through a front surface of the display device DD. The anti-reflection layer RPL may include a phase retarder and a polarizer. The phase retarder may be a film type or a liquid-crystal coating type, and may include a λ/2-phase retarder and/or λ/4-phase retarder. The polarizer may also be a film type or a liquid-crystal coating type. The film type may include a stretching-type synthetic resin film, and the liquid-crystal coating type may include liquid crystals arranged in a predetermined arrangement. The phase retarder and polarizer may be provided as one polarizing film. The functional layer may further include a protective film disposed above or under the anti-reflection layer RPL.

The lower module LM may include a support plate SP disposed on a rear surface of the display module DM to support the display module DM, and a protective film PF disposed between the display module DM and the support plate SP. The support plate SP may include support plates the number of which corresponds to the number of non-folding regions NFA1 and NFA2. According to an embodiment of the inventive concept, the support plate SP may include a first support plate SP1 and a second support plate SP2 disposed apart from the first support plate SP1.

The first and second support plates SP1 and SP2 may be disposed corresponding to the first and second non-folding regions NFA1 and NFA2, respectively. The first support plate SP1 may be disposed overlapping the first non-folding region NFA1 of the display module DM, and the second support plate SP2 may be disposed overlapping the second non-folding region NFA2 of the display module DM. The first and second support plates SP1 and SP2 may each include a metal material or plastic material.

When the display module DM is unfolded as illustrated in FIG. 1, the first and second support plates SP1 and SP2 are disposed and spaced apart from each other in a first direction DR1. When the display module DM is folded with respect to a folding axis FX as illustrated in FIG. 2, the first and second support plates SP1 and SP2 may be disposed and spaced apart from each other in a third direction DR3.

The first and second support plates SP1 and SP2 may be spaced apart from each other in correspondence to a folding region FA. The first and second support plates SP1 and SP2 may partially overlap the folding region FA. That is, a distance between the first and second support plates SP1 and SP2 in the first direction DR1 may be smaller than the width of the folding region FA in the first direction DR1.

Although not illustrated in the drawing, the support plate SP may further include a connection module for connecting the first and second support plates SP1 and SP2 to each other. The connection module may include a hinge module or a multi-joint module.

It is illustrated that the support plate SP includes two support plates SP1 and SP2, but an embodiment of the inventive concept is not limited thereto. That is, when a plurality of folding axes FX are provided, the support plate SP may include a plurality of support plates separated with respect to the plurality of folding axes FX. In addition, the support plate SP may not be divided into the first and second support plates SP1 and SP2, but provided as an integrated shape. In this case, a bending part may be provided to the support plate SP in correspondence to the folding region FA. In the bending part, an opening that is formed by passing through the support plate SP may be provided, or a groove, depressed from one surface of the support plate SP, may be provided.

The protective film PF may be disposed between the display module DM and the support plate SP. The protective film PF may be disposed under the display module DM to protect the rear surface of the display module DM. The protective film PF may include a synthetic resin film, which may be, for example, a polyimide film or a polyethylene terephthalate film. However, this is an example, and the protective film PF is not limited to the aforementioned example.

The housing HU may be coupled to the display device DD, particularly to the window WM, to accommodate the display module DM and the lower module LM. It is illustrated that the housing HU includes first and second housings HU1 and HU2 separated from each other, but an embodiment of the inventive concept is not limited thereto. Although not illustrated in the drawing, the electronic device ED may further include a hinge structure for connecting the first and second housings HU1 and HU2.

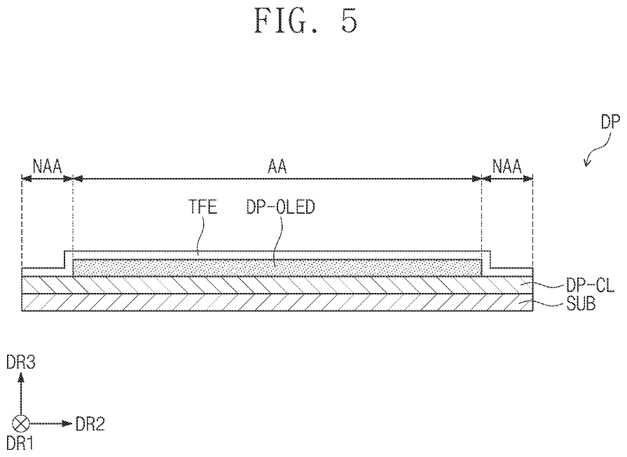

FIG. 5 is a cross-section view of the display panel DP illustrated in FIG. 3.

FIG. 5 exemplarily illustrates a cross-section of the display panel DP when viewed from a first direction DR1.

Referring to FIG. 5, the display panel DP may include a substrate SUB, a circuit element layer DP-CL disposed on the substrate SUB, a thin-film encapsulation layer TFE disposed on the circuit element layer DP-CL.

The substrate SUB may include an active region AA and a peripheral region NAA around the active region AA. The substrate SUB may include a flexible plastic material such as polyimide (PI). A display element layer DP-OLED may be disposed on the active region AA.

A plurality of pixels may be disposed in the active region AA. The pixels may each include a light-emitting element disposed on the display element layer DP-OLED and connected to a transistor disposed on the circuit element layer DP-CL.

The thin-film encapsulation layer TFE may be disposed on the circuit element layer DP-CL to cover the display element layer DP-OLED. The thin-film encapsulation layer TFE may include inorganic layers and an organic layer between the inorganic layers. The inorganic layers may protect the pixels from moisture/oxygen. The organic layer may protect the pixels PX from foreign substances such as dust particles.

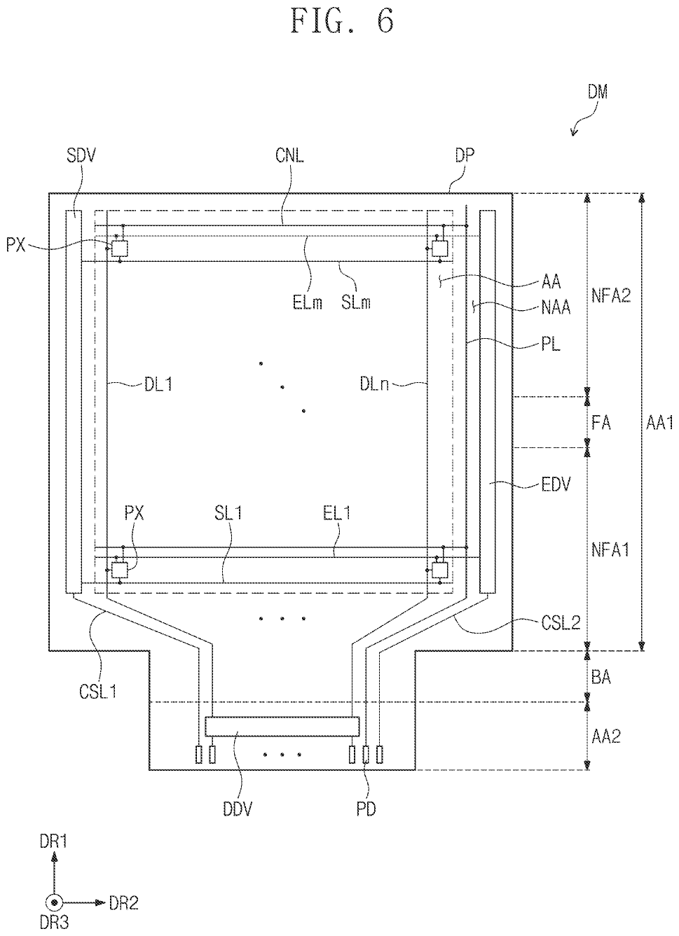

FIG. 6 is a plan view of the display module DM including the display panel DP illustrated in FIG. 5.

Referring to FIG. 6, the display module DM may include the display panel DP, a scan driver SDV, a data driver DDV, and an emission driver EDV.

The display panel DP may include a first region AA1, a second region AA2, and a bending region BA between the first region AA1 and the second region AA2. The bending region BA may extend in a second direction DR2, and the first region AA1, the bending region BA, and the second region AA2 may be arranged in a first direction DR1.

The first region AA1 may include an active region AA and a peripheral region NAA around the active region AA. The peripheral region NAA may surround the active region AA. The active region AA may be a region in which an image is displayed, and the peripheral region NAA may be a region in which an image is not displayed. The second region AA2 and the bending region BA may be regions in which an image is not displayed.

The first region AA1, when viewed from the second direction DR2, may include a first non-folding region NFA1, a second non-folding region NFA2, and a folding region FA between the first non-folding region NFA1 and the second non-folding region NFA2.

The display panel DP may include a plurality of pixels PX, a plurality of scan lines SL1 through SLm, a plurality of data lines DL1 through DLn, a plurality of emission lines EL1 through ELm, first and second control lines CSL1 and CSL2, a power line PL, a plurality of connection lines CNL, and a plurality of pads PD, where m and n are each a natural number. The pixels PX may be disposed in the active region AA, and connected to the scan lines SL1 through SLm, the data lines DL1 through DLn, and the emission lines EL1 through ELm.

The scan driver SDV and the emission driver EDV may be disposed in the peripheral region NAA. The scan driver SDV and the emission driver EDV may be disposed in regions of the peripheral region NAA respectively adjacent to both sides of the first region AA1 which are opposed to each other in the second direction DR2. The data driver DDV may be disposed in the second region AA2. The data driver DDV may be manufactured as an integrated circuit chip, and mounted on the second region AA2.

The scan lines SL1 through SLm may extend in the second direction DR2 to be connected to the scan driver SDV. The data lines DL1 through DLn may extend in the first direction DR1, and may be connected to the data driver DDV via the bending region BA. The emission lines EL1 through ELm may extend in the second direction DR2 to be connected to the emission driver EDV.

The power line PL may extend in the first direction DR1, and may be disposed in the peripheral region NAA. The power line PL may be disposed between the active region AA and the emission driver EDV. However, an embodiment of the inventive concept is not limited thereto, and the power line PL may be disposed between the active region AA and the scan driver SDV.

The power line PL may extend to the second region AA2 via the bending region BA. The power line PL, when viewed on a plane, may extend toward a lower part of the second region AA2. The power line PL may receive a driving voltage.

The connection lines CNL may extend in the second direction DR2, and may be arranged in the first direction DR1. The connection lines CNL may be connected to the power line PL and the pixels PX. The driving voltage may be applied to the pixels PX through the power line PL and the connection lines CNL which are connected to each other.

The first control line CSL1 may be connected to the scan driver SDV, and may extend toward the lower part of the second region AA2 via the bending region BA. The second control line CSL2 may be connected to the emission driver EDV, and may extend toward the lower part of the second region AA2 via the bending region BA. The data driver DDV may be disposed between the first control line CSL1 and the second control line CSL2.

When viewed on a plane, the pads PD may be disposed adjacent to the lower part of the second region AA2. The data driver DDV, the power line PL, the first control line CSL1, and the second control line CSL2 may be connected to the pads PD.

The data lines DL1 through DLn may be connected to the corresponding pads PD through the data driver DDV. For example, the data lines DL1 through DLn may be connected to the data driver DDV, and the data driver DDV may be connected to the pads PD respectively corresponding to the data lines DL1 through DLn.

Although not illustrated in the drawing, a printed circuit board may be connected to the pads PD, and a timing controller and a voltage generator may be disposed on the printed circuit board. The timing controller may be manufactured as an integrated circuit chip and mounted on the printed circuit board. The timing controller and the voltage generator may be connected to the pads PD through the printed circuit board.

The timing controller may control operations of the scan driver SDV, the data driver DDV, and the emission driver EDV. In response to control signals received from the outside, the timing controller may generate a scan control signal, a data control signal, and an emission control signal. The voltage generator may generate a driving voltage.

The scan control signal may be provided to the scan driver SDV through the first control line CSL1. The emission control signal may be provided to the emission driver EDV through the second control line CSL2. The data control signal may be provided to the data driver DDV. The timing controller may receive image signals from the outside, convert the data format of the image signals to be compatible with interface specifications of the data driver DDV, and provide the converted image signals to the data driver DDV.

The scan driver SDV may generate a plurality of scan signals in response to the scan control signal. The scan signals may be applied to the pixels PX through the scan lines SL1 through SLm. The scan signals may be sequentially applied to the pixels PX.

In response to the data control signal, the data driver DDV may generate a plurality of data voltages corresponding to the image signals. The data voltages may be applied to the pixels PX through the data lines DL1 through DLn. The emission driver EDV may generate a plurality of emission signals in response to the emission control signal. The emission signals may be applied to the pixels PX through the emission lines EL1 through ELm.

The pixels PX may receive the data voltages in response to the scan signals. The pixels PX may display an image by emitting light in brightness corresponding to the data voltages in response to the emission signals. Emission times of the pixels PX may be controlled by the emission signals.

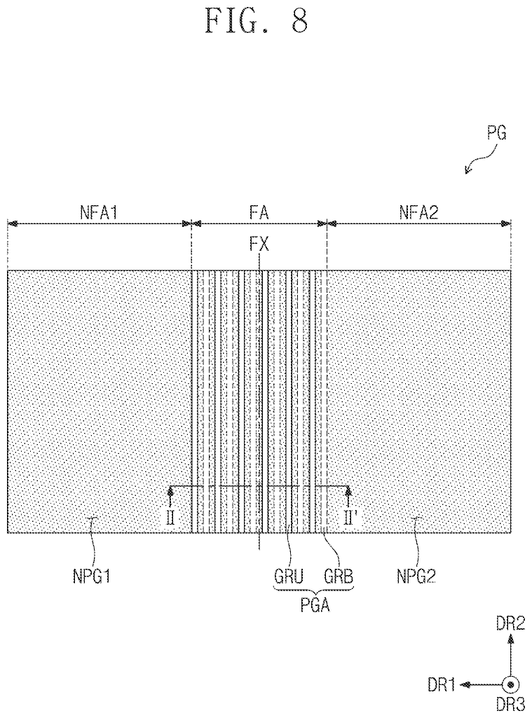

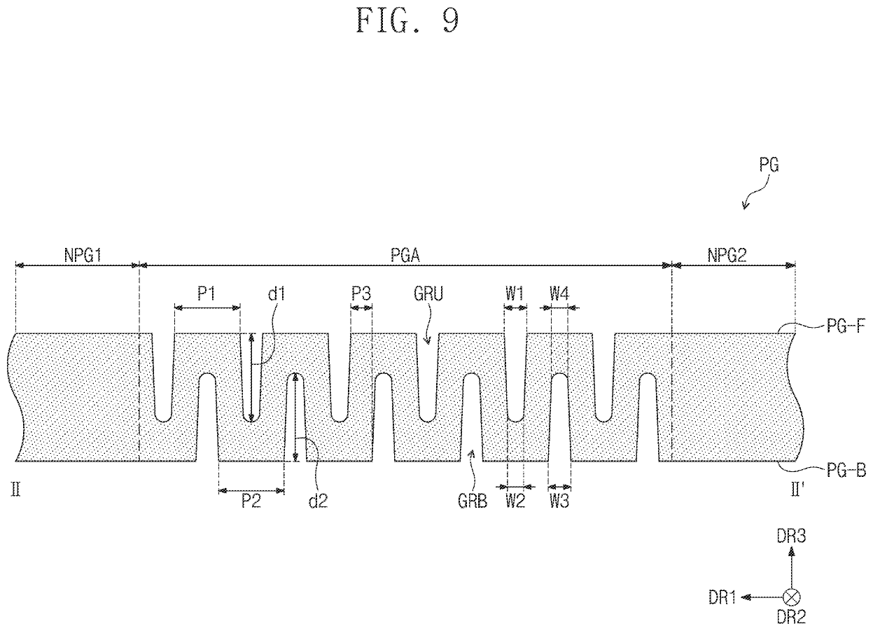

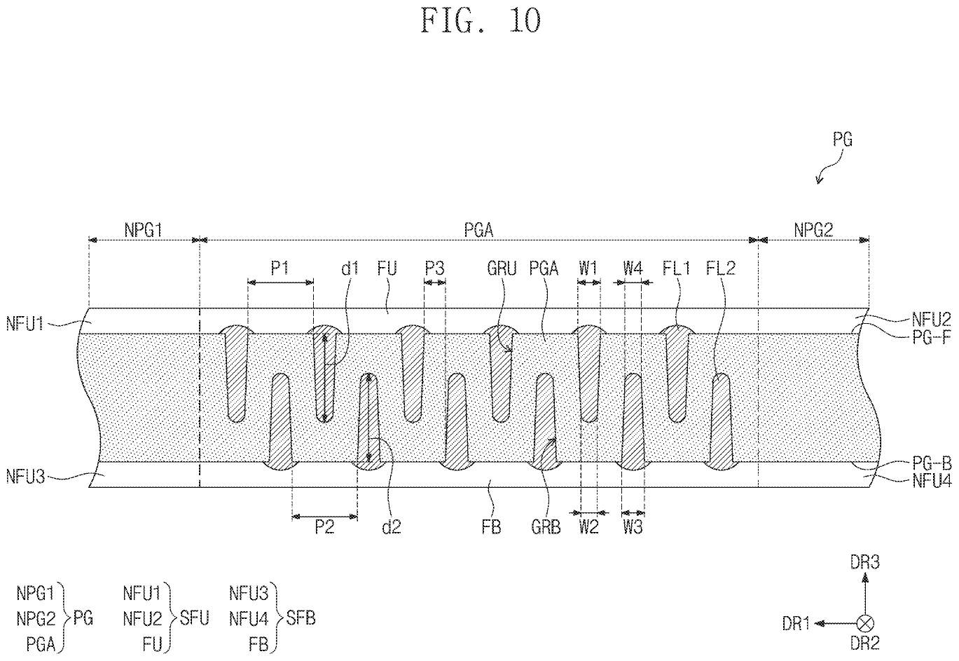

FIG. 7 is an enlarged view of the first region A1 of FIG. 4. FIG. 8 is a plan view of a pattern glass PG illustrated in FIG. 7. FIG. 9 is a cross-sectional view taken along line II-II′ of FIG. 8. FIG. 10 is a cross-sectional view of a pattern glass PG on which filling patterns FL1, FL2, an upper, e.g., first, resin layer SFU, and a lower, e.g., second, resin layer SFB are disposed.

FIGS. 7, 9 and 10 are exemplarily illustrated cross-sectional views, and FIG. 8 is an exemplarily illustrated plan view.

First and second support plates SP1 and SP2, an anti-reflection layer RPL, a protective film PF, and a display module DM in FIG. 7 are respectively same as the first and second support plates SP1 and SP2, the anti-reflection layer RPL, the protective film PF, and the display module DM in FIGS. 3 and 4, and thus the descriptions thereof will be omitted or simplified.

Referring to FIGS. 7, 8, and 9, the window WM may include the pattern glass PG, a first window adhesive layer W_AL1, a second window adhesive layer W_AL2, a protective layer PL, an upper resin layer SFU, a lower resin layer SFB, and filling patterns FL1 and FL2.

The pattern glass PG may include a glass material. The pattern glass PG may include a pattern part PGA, and first and second non-pattern parts NPG1 and NPG2. The first non-pattern part NPG1, the pattern part PGA, and the second non-pattern part NPG2 may be arranged in a first direction DR1. The pattern part PGA may be disposed between the first and second non-pattern parts NPG1 and NPG2 in the first direction DR1. Substantially, the first non-pattern part NPG1, the pattern part PGA, and the second non-pattern part NPG2 may be integrally formed.

The pattern part PGA may overlap a folding region FA. The first non-pattern part NPG1 may overlap a first non-folding region NFA1. The second non-pattern part NPG2 may overlap a second non-folding region NFA2.

The pattern glass PG may include an upper, e.g., first, surface PG-F and a lower, e.g., second, surface PG-B. The upper surface PG-F and the lower surface PG-B may refer to two surfaces of the pattern glass PG opposed to each other in a third direction DR3. Herein, “the upper surface” of a feature is sometimes referred to as “the first surface” and “the lower surface” of a feature is sometimes referred to as “the second surface”. Generally, the term “upper” is sometimes referred to as the “first” and the term “lower” is sometimes referred to as the “second”.

A plurality of first grooves GRU and a plurality of second grooves GRB may be defined on the pattern part PGA. The first grooves GRU may be defined in the upper surface PG-F of the pattern glass PG. When viewed on a plane, the first grooves GRU may extend in a second direction DR2, and spaced apart from each other in the first direction DR1. The first grooves GRU may each extend from the upper surface PG-F toward the lower surface PG-B in the third direction DR3. The first grooves GRU may each extend by a length greater than a half of the thickness of the pattern glass PG. The first grooves GRU may each have a depth greater than a half of the thickness of the pattern glass PG.

The first grooves GRU may be recessed downward. A first width W1 of an upper part of each of the first grooves GRU adjacent to the upper surface PG-F of the pattern glass PG may be greater than a second width W2 of a lower part of each of the first grooves GRU adjacent to the lower surface PG-B of the pattern glass PG. Bottom surfaces of the first grooves GRU may have curved surfaces.

The second grooves GRB may be defined in the lower surface PG-B of the pattern glass PG. When viewed on a plane, the second grooves GRB may extend in the second direction DR2, and spaced apart from each other in the first direction DR1. The second grooves GRB may each extend from the lower surface PG-B toward the upper surface PG-F in the third direction DR3. The second grooves GRB may each extend by a length greater than a half of the thickness of the pattern glass PG. The second grooves GRB may each have a depth greater than a half of the thickness of the pattern glass PG.

The second grooves GRB may protrude upward. A third width W3 of a lower part of each of the second grooves GRB adjacent to the lower surface PG-B of the pattern glass PG may be greater than a fourth width W4 of an upper part of each of the second grooves GRB adjacent to the upper surface PG-F of the pattern glass PG. Upper surfaces of the second grooves GRB may have curved surfaces.

For example, the first grooves GRU and the second grooves GRB may have the same shape. In this case, the first and third widths W1 and W3 may be equal to each other, and the second and fourth widths W2 and W4 may be equal to each other. However, an embodiment of the inventive concept is not limited thereto. Alternatively, each of the first grooves GRU may have a shape different from that of each of the second grooves GRB. In this case, the first and third widths W1 and W3 may differ from each other, and the second and fourth widths W2 and W4 may differ from each other.

The sizes of the first through fourth widths W1 through W4 may be determined according to folding characteristics. In addition, the sizes of the first and second widths W1 and W2 may be adjusted according to a depth d1 (hereinafter, first depth) of each of first grooves GRU. The sizes of the third and fourth widths W3 and W4 may be adjusted according to a depth d2 (hereinafter, second depth) of each of second grooves GRB. According to an embodiment of the inventive concept, the first depth d1 may be same as the second depth d2. Alternatively, the first depth d1 may be different from the second depth d2.

When viewed from the second direction DR2, the first grooves GRU and the second grooves GRB may be defined in a staggered manner. The first grooves GRU and the second grooves GRB may not overlap each other. For example, the first grooves GRU may be spaced apart from each other by a first distance P1 in the first direction DR1. The second grooves GRB may be spaced apart from each other by a second distance P2 in the first direction DR1. The first distance P1 and the second distance P2 may be equal to each other. The first and second grooves GRU and GRB adjacent to each other in the first direction DR1 may be spaced apart from each other by a third distance P3. The third distance P3 may be smaller than the first and second distances P1 and P2.

Referring to FIGS. 7 and 10, each of the first filling patterns FL1 may be disposed in the corresponding first groove GRU among the first grooves GRU. Each of the second filling patterns FL2 may be disposed in the corresponding second groove GRB among the second grooves GRB.

When viewed from the second direction DR2, the first filling patterns FL1 may be spaced apart from each other in the first direction DR1. When viewed from the second direction DR2, the second filling patterns FL2 may be spaced apart from each other in the first direction DR1. When viewed from the second direction DR2, the first and second filling patterns FL1 and FL2 may be disposed in a staggered manner.

Upper surfaces, sometimes called outer surfaces, of the first filling patterns FL1 may protrude more than the upper surface PG-F of the pattern glass PG. The upper surfaces of the first filling patterns FL1 may be more adjacent to the protective layer PL, to be described later, than the upper surface PG-F of the pattern glass PG is. For example, the first filling patterns FL1 may protrude by about 1 μm to about 3 μm from the upper surface PG-F of the pattern glass PG. The upper surfaces of the first filling patterns FL1 may be defined as surfaces facing the protective layer PL to be described later.

Lower surfaces, sometimes called outer surfaces, of the second filling patterns FL2 may protrude more than the lower surface PG-B of the pattern glass PG. The lower surfaces of the second filling patterns FL2 may be spaced farther apart from the upper surface PG-F of the pattern glass PG than the lower surface PG-B of the pattern glass PG. The lower surfaces of the second filling patterns FL2 may be more adjacent to the display module DM than the lower surface PG-B of the pattern glass PG is. For example, the second filling patterns FL2 may protrude by about 1 μm to about 3 μm from the lower surface PG-B of the pattern glass PG. The lower surfaces of the second filling patterns FL2 may be defined as surfaces facing the display module DM.

Substantially, the first and second filling patterns FL1 and FL2 may include the same material. For example, the first and second filling patterns FL1 and FL2 may each include a synthetic resin material. The first and second filling patterns FL1 and FL2 may each include a material having the same refractive index as that of the pattern glass PG. For example, the first and second filling patterns FL1 and FL2 may each include at least one selected from among a urethane-based resin, an epoxy-based resin, a polyester-based resin, a polyether-based resin, an acrylate-based resin, an acrylonitrile-butadiene-styrene (ABS) resin, and rubber. In particular, the first and second filling patterns FL1 and FL2 may each include at least one of phenylene, polyethyleneterephthalate (PET), polyimide (PI), polyamide (PAI), polyethylene naphthalate (PEN), or polycarbonate (PC).

In the case where the upper surfaces of the first filling patterns FL1 and the lower surfaces of the second filling patterns FL2 are lower than and higher than, e.g., recessed within, the upper surface PG-F and the lower surface PG-B of the pattern glass PG, respectively, there may be step differences between the upper resin layer SFU to be described later and the first filling patterns FL1, and between the lower resin layer SFB to be described later and the second filling patterns FL2. In this case, when the upper resin layer SFU and the lower resin layer SFB are applied, the heights of the resins overlapping the first and second grooves GRU and GRB may be different from the heights of the resins disposed between the grooves adjacent to each other in the first direction DR1. In this case, the resins may be sunken along the first and second grooves GRU and GRB. Therefore, the shapes of the first grooves GRU and the second grooves GRB of the pattern part PGA may be visible from the outside.

However, since the first and second filling patterns FL1 and FL2 according to an embodiment of the inventive concept may be formed to be higher than and lower than, e.g., protrude from, the upper surface PG-F and the lower surface PG-B, respectively, the step differences between the upper resin layer SFU and the first filling patterns FL1, and between the lower resin layer SFB and the second filling patterns FL2, may be removed. According to this structure, when the upper resin layer SFU and the lower resin layer SFB are applied, the heights of the resins respectively overlapping the first and second grooves GRU and GRB may be same as the heights of the resins disposed between the grooves adjacent to each other in the first direction DR1. Therefore, the resins may not be sunken, and the shapes of the first grooves GRU and the second grooves GRB of the pattern part PGA may be invisible from the outside.

The upper resin layer SFU may be disposed on the upper surface PG-F of the pattern glass PG. The upper resin layer SFU may include a first part NFU1, a second part NFU2, and an upper pattern layer FU. The first part NFU1, the upper pattern layer FU, and the second part NFU2 may be arranged in the first direction DR1. The upper pattern layer FU may be disposed between the first part NFU1 and the second part NFU2. Substantially, the first part NFU1, the upper pattern layer FU, and the second part NFU2 may be integrally formed.

The upper pattern layer FU may be disposed on an upper surface of the pattern part PGA. The upper pattern layer FU may overlap the folding region FA. The upper pattern layer FU may cover the upper surface of the pattern part PGA and the first filling patterns FL1. The height of the upper surface of the upper pattern layer FU may be same as the height of an upper surface of each of the first and second parts NFU1 and NFU2 to be described later.

The first part NFU1 may be disposed on an upper surface of the first non-pattern part NPG1. The first part NFU1 may overlap the first non-folding region NFA1. The second part NFU2 may be disposed on an upper surface of the second non-pattern part NPG2. The second part NFU2 may overlap the second non-folding region NFA2. For example, the thicknesses of the first part NFU1 and the second part NFU2 may be about 14 μm to about 20 μm.

For example, the first and second parts NFU1 and NFU2 and the upper pattern layer FU may include the same material. For example, the first and second parts NFU1 and NFU2 and the upper pattern layer FU may each include a synthetic resin material. The first and second parts NFU1 and NFU2 and the upper pattern layer FU may each include a material having the same refractive index as that of the pattern glass PG. For example, the first and second parts NFU1 and NFU2 and the upper pattern layer FU may each include at least one selected from among a urethane-based resin, an epoxy-based resin, a polyester-based resin, a polyether-based resin, an acrylate-base resin, an acrylonitrile-butadiene-styrene (ABS) resin, and rubber. In particular, the first and second parts NFU1 and NFU2 and the upper pattern layer FU may each include at least one of phenylene, polyethyleneterephthalate (PET), polyimide (PI), polyamide (PAI), polyethylene naphthalate (PEN), or polycarbonate (PC). However, an embodiment of the inventive concept is not limited thereto, and the first and second parts NFU1 and NFU2 and the upper pattern layer FU may include different materials.

For example, the upper resin layer SFU and the first filling patterns FL1 may include different materials. However, an embodiment of the inventive concept is not limited thereto, and the upper resin layer SFU and the first filling patterns FL1 may include the same material.

The lower resin layer SFB may be disposed on the lower surface PG-B of the pattern glass PG. The lower resin layer SFB may include a third part NFU3, a fourth part NFU4, and a lower pattern layer FB. The third part NFU3, the lower pattern layer FB, and the fourth part NFU4 may be arranged in the first direction DR1. The lower pattern layer FB may be disposed between the third part NFU3 and the fourth part NFU4. Substantially, the third part NFU3, the lower pattern layer FB, and the fourth part NFU4 may be integrally formed.

The lower pattern layer FB may be disposed on a lower surface of the pattern part PGA. The lower pattern layer FB may overlap the folding region FA. The lower pattern layer FB may cover the lower surface of the pattern part PGA and the second filling patterns FL2.

The third part NFU3 may be disposed on a lower surface of the first non-pattern part NPG1. The third part NFU3 may overlap the first non-folding region NFA1. The fourth part NFU4 may be disposed on a lower surface of the second non-pattern part NPG2. The fourth part NFU4 may overlap the second non-folding region NFA2.

For example, the third and fourth parts NFU3 and NFU4 and the lower pattern layer FB may include the same material. However, an embodiment of the inventive concept is not limited thereto, and the third and fourth parts NFU3 and NFU4 and the lower pattern layer FB may have different materials.

For example, the lower resin layer SFB and the second filling patterns FL2 may include different materials. However, an embodiment of the inventive concept is not limited thereto, and the lower resin layer SFB and the second filling patterns FL2 may have the same material.

Referring to FIG. 7, the protective layer PL may be disposed on the pattern glass PG. The protective layer PL may be disposed on the upper resin layer SFU. The protective layer PL may serve to protect the pattern glass PG from external impact. The protective layer PL may include a synthetic resin material. According to an embodiment of the inventive concept, the protective layer PL may include at least one selected from among a urethane-based resin, an epoxy-based resin, a polyester-based resin, a polyether-based resin, an acrylate-based resin, an acrylonitrile-butadiene-styrene (ABS) resin, and rubber. In particular, the protective layer PL may include at least one of phenylene, polyethyleneterephthalate (PET), polyimide (PI), polyamide (PAI), polyethylene naphthalate (PEN), or polycarbonate (PC).

The first window adhesive layer W_AL1 may be disposed on the pattern glass PG. The first window adhesive layer W_AL1 may be disposed on an upper surface of the upper resin layer SFU. The first window adhesive layer W_AL1 may be disposed between the protective layer PL and the upper resin layer SFU to bond the protective layer PL to the upper resin layer SFU.

The first window adhesive layer W_AL1 may include an optically transparent adhesive material. For example, the first window adhesive layer W_AL1 may include a pressure sensitive adhesive (PSA), an optically clear adhesive (OCA), or an optical clear resin (OCR).

The second window adhesive layer W_AL2 may be disposed under the pattern glass PG. The second window adhesive layer W_AL2 may be disposed on a lower surface of the lower resin layer SFB. The second window adhesive layer W_AL2 may be disposed between the anti-reflection layer RPL and the lower resin layer SFB to bond the anti-reflection layer RPL to the lower resin layer SFB. A first adhesive film AF1 may be disposed between the anti-reflection layer RPL and the display module DM to bond the anti-reflection layer RPL to the display module DM. A second adhesive film AF2 may be disposed between the display module DM and the protective film PF to bond the display module DM to the protective film PF. Third adhesive films AF3_1, AF3_2 may be disposed between the protective film PF and the support plates SP1, SP2 to bond the protective film PF to the support plates SP1, SP2, respectively.

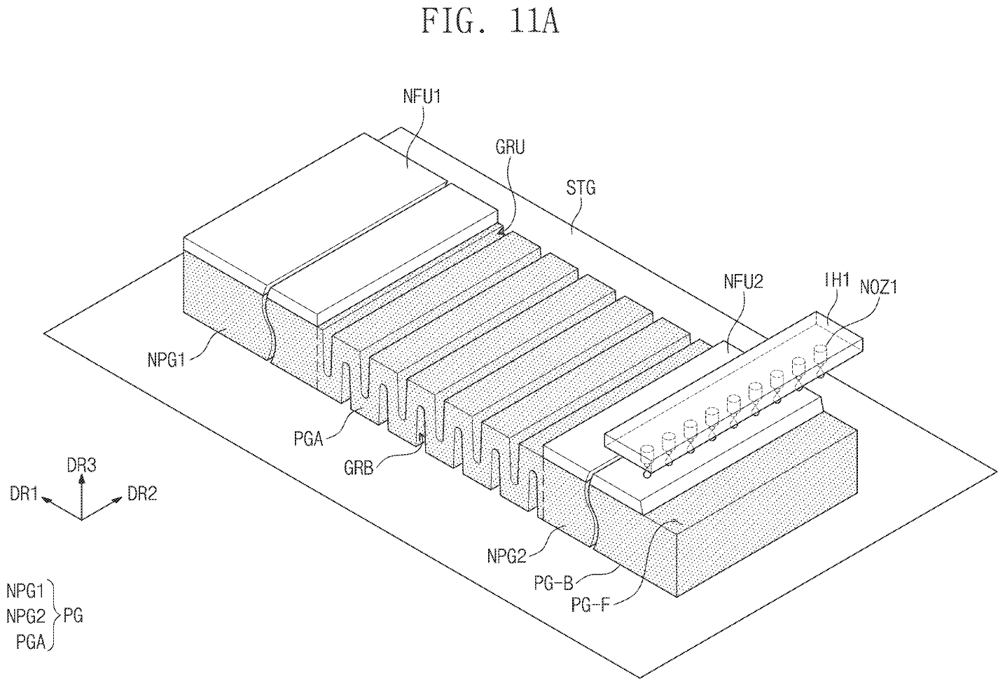

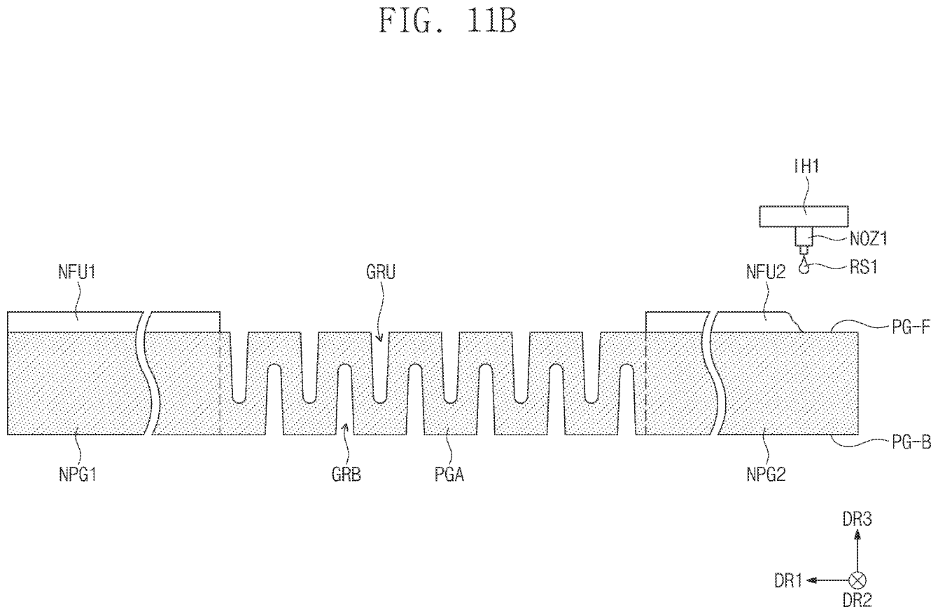

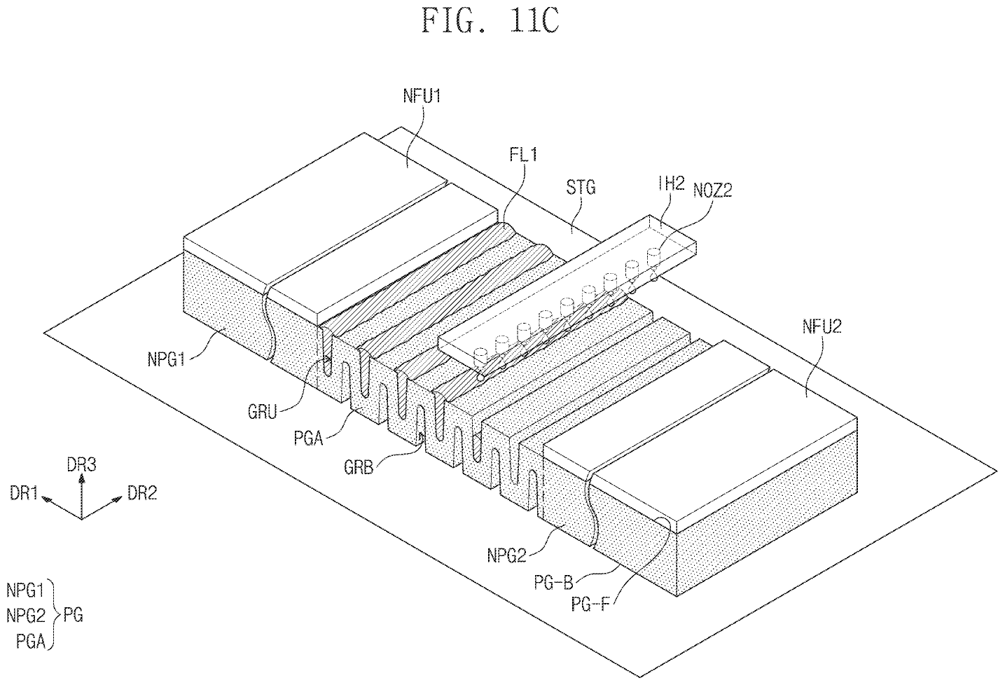

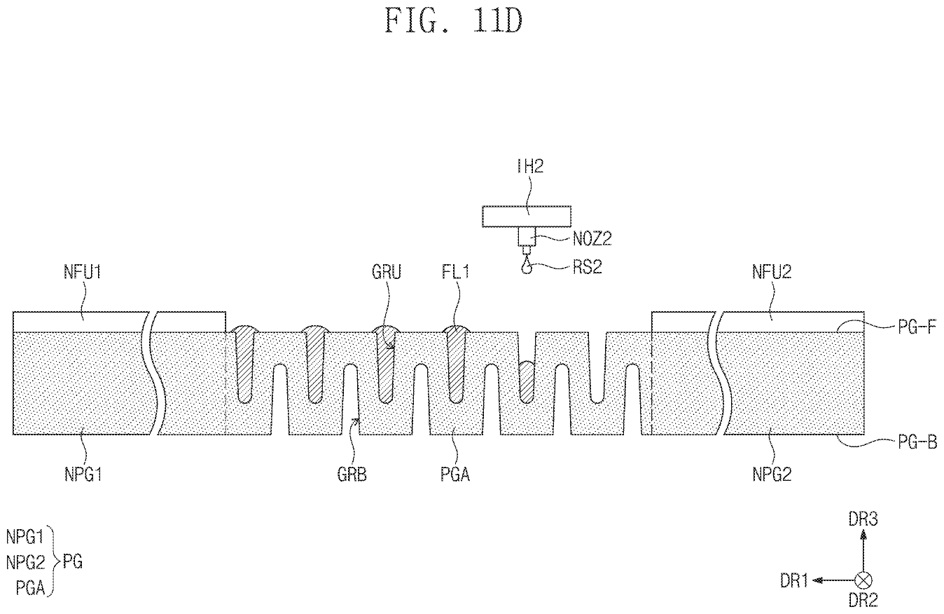

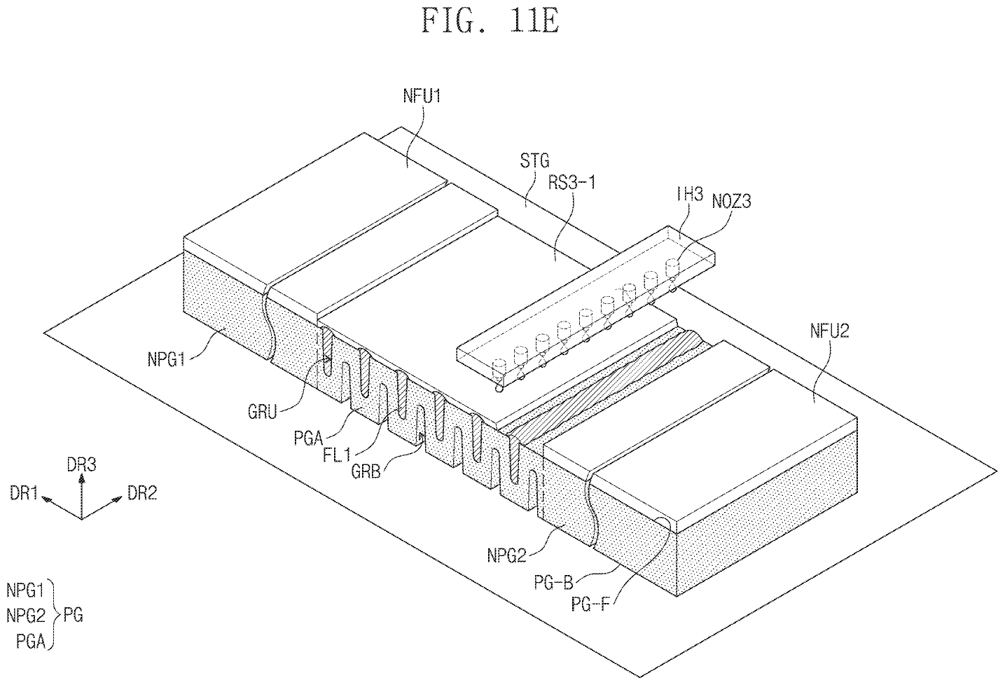

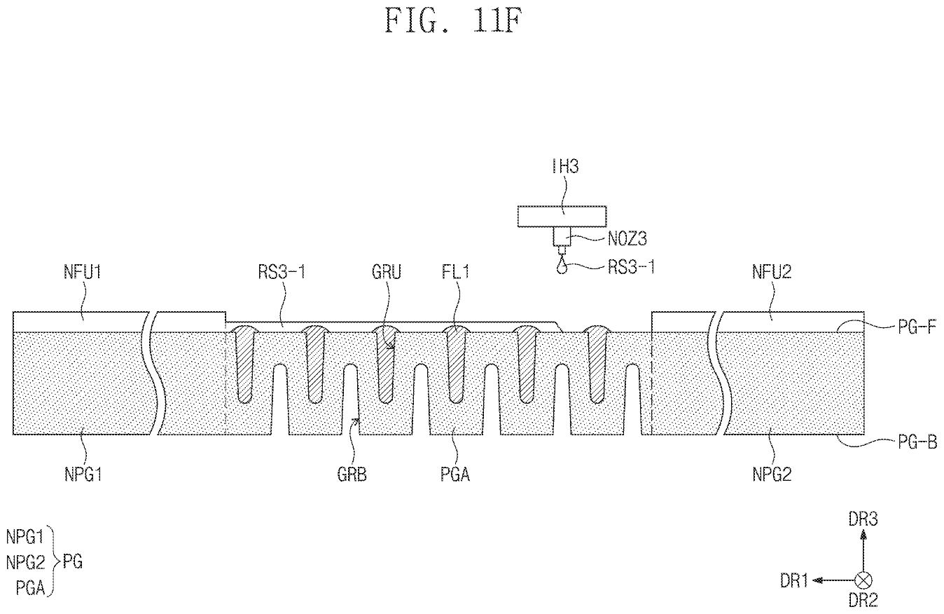

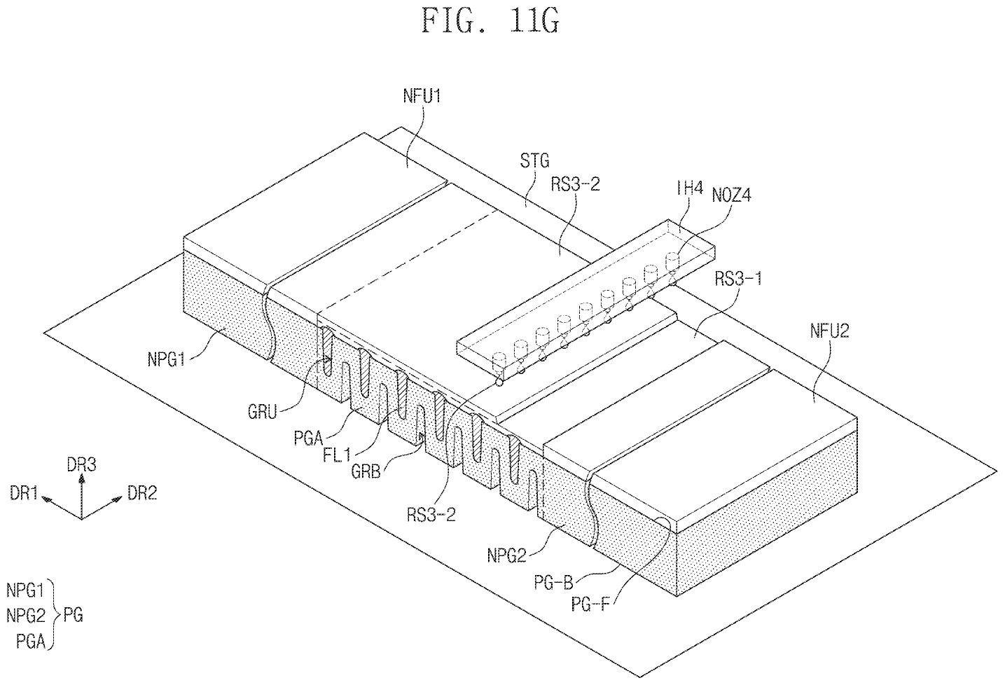

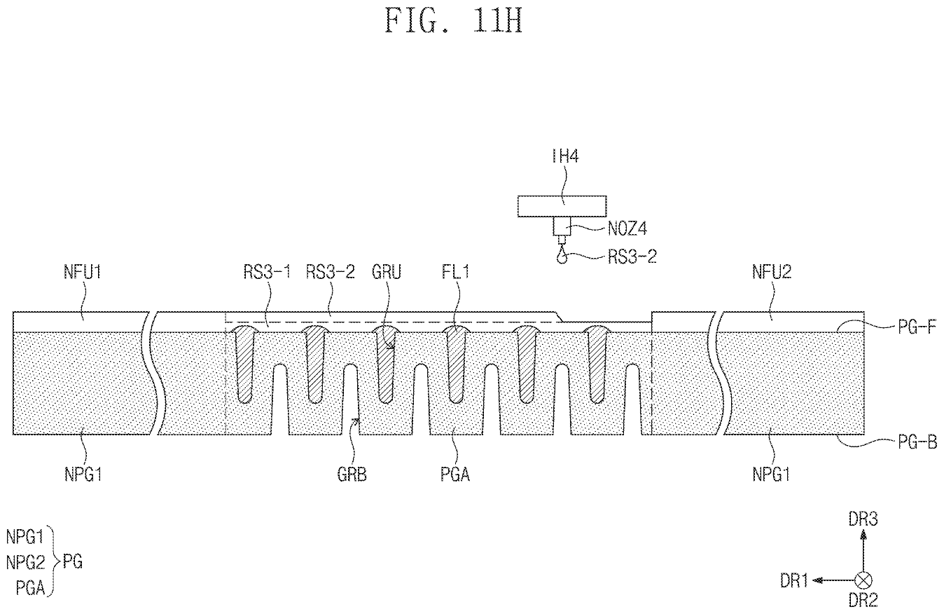

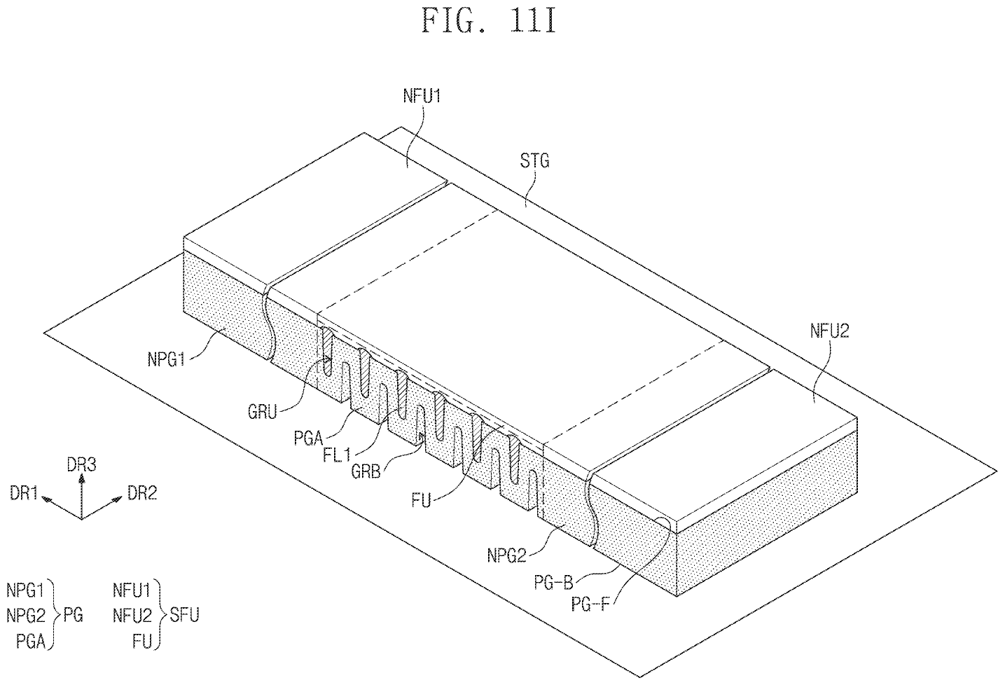

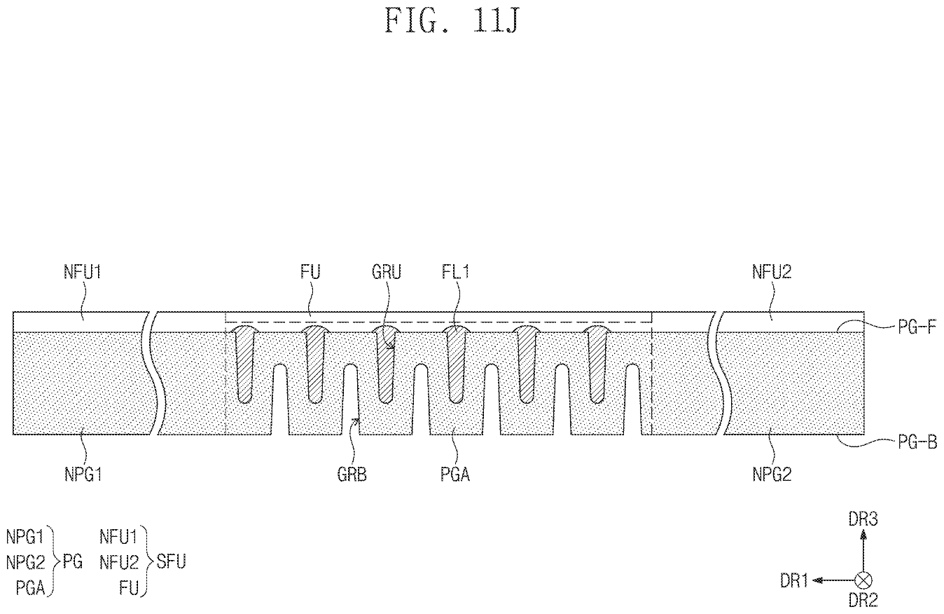

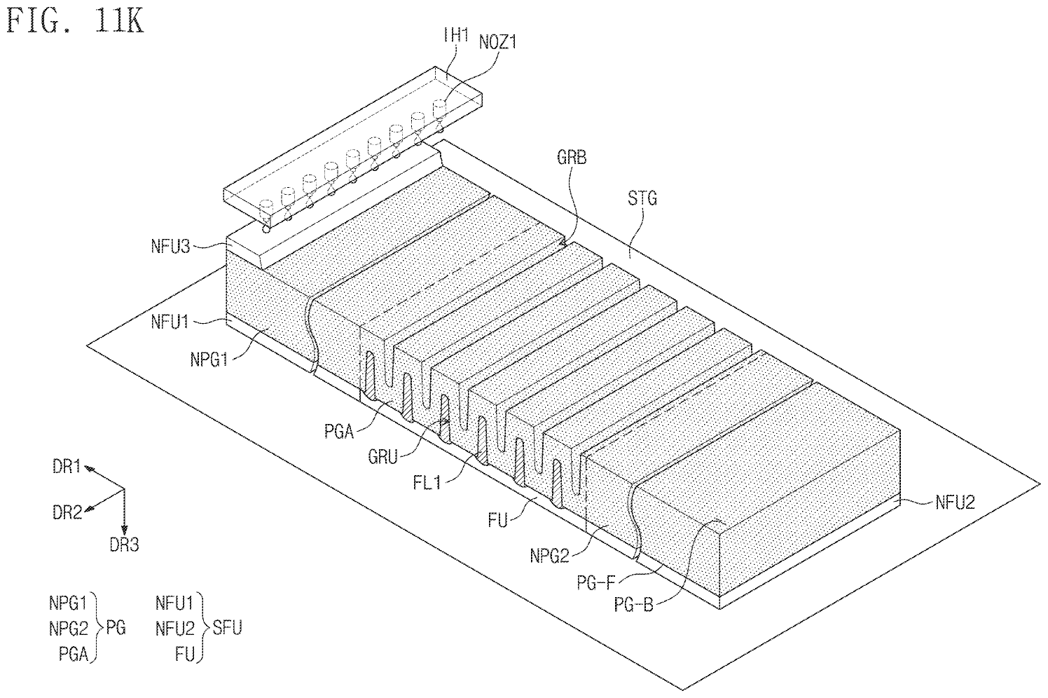

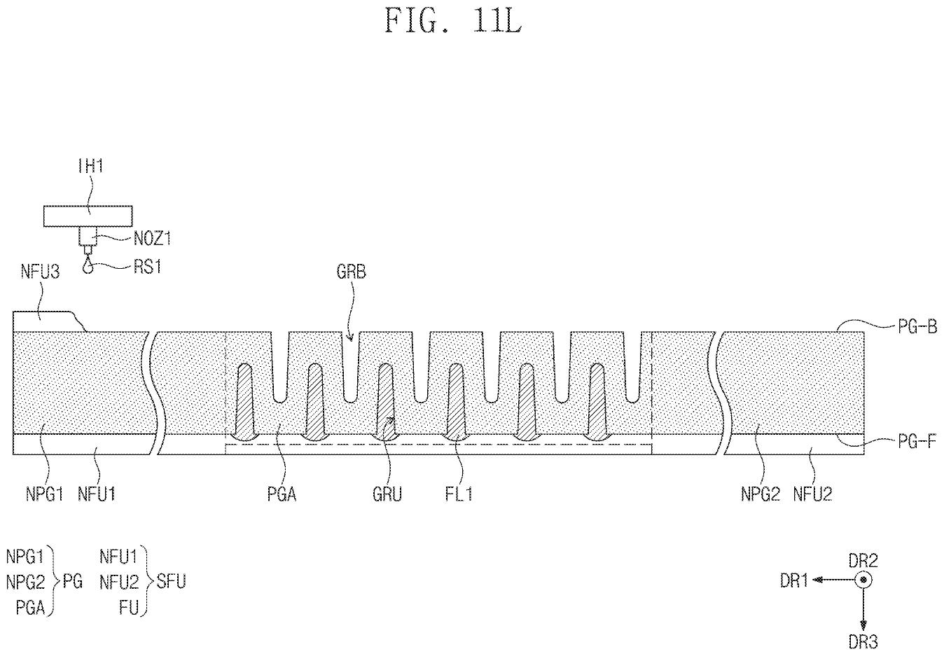

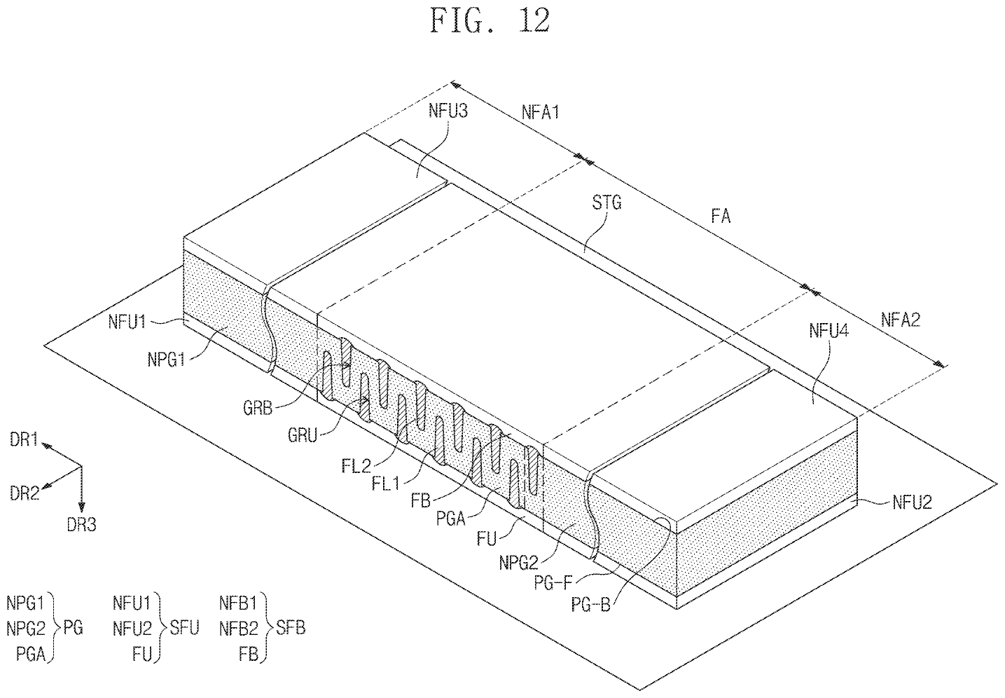

FIGS. 11A, 11B, 11C, 11D, 11E, 11F, 11G, 11H, 11I, 11J, 11K, and 11L are views illustrating a window manufacturing method according to an embodiment of the inventive concept. FIG. 12 is a perspective view of an upper resin layer and a lower resin layer manufactured according to the method illustrated in FIGS. 11A through 11L.

For example, FIGS. 11A, 11C, 11E, 11G, 11I, 11K, and 12 are perspective views, and FIGS. 11B, 11D, 11F, 11H, 11J, and 11L are side views viewed from the second direction DR2.

A pattern glass PG in FIGS. 11A through 11L is same as the pattern glass PG in FIGS. 7 through 10, and thus the description thereof will be omitted or simplified.

Referring to FIGS. 11A and 11B, the pattern glass PG may be provided on a stage STG. When viewed on a plane, first grooves GRU defined on a pattern part PGA may extend in a second direction DR2, and may be arranged in a first direction DR1. When viewed on a plane, second grooves GRB may extend in the second direction DR2 and may be arranged in the first direction DR1.

The first grooves GRU may be defined on an upper surface PG-F of the pattern glass PG. The first grooves GRU may extend from the upper surface PG-F toward a lower surface PG-B of the pattern glass PG in a third direction DR3.

The second grooves GRB may be defined on the lower surface PG-B of the pattern glass PG. The second grooves GRB may extend from the lower surface PG-B toward the upper surface PG-F of the pattern glass PG in the third direction DR3.

A first inkjet head IH1 and first nozzles NOZ1 may be disposed on the pattern glass PG. The first inkjet head IH1 may extend in the second direction DR2. When viewed on a plane, the first inkjet head IH1 may have a rectangular shape.

A plurality of first nozzles NOZ1 may be disposed on a lower surface of the first inkjet head IH1. The first nozzles NOZ1 may be arranged in the second direction DR2. For example, in FIG. 11A, nine first nozzles NOZ1 are illustrated, but the number of the first nozzles NOZ1 is not limited, and more first nozzles NOZ1 may be included.

The first nozzles NOZ1 may discharge first resins RS1. The amounts of the first resins RS1 discharged per hour by the respective first nozzles NOZ1 may be equal to each other. The first resin RS1 may include a photocurable material.

The first nozzles NOZ1 may discharge the first resins RS1 onto the first non-pattern part NPG1 and the second non-pattern part NPG2. The first nozzles NOZ1 may not discharge the first resins RS1 onto the pattern part PGA.

Although not illustrated in the drawing, the first resins RS1 may be provided to the first and second non-pattern parts NPG1 and NPG2, and then curing may be performed through chemical curing and UV curing. The first resin RS1 may be cured on the first non-pattern part NPG1 to form the first part NFU1 of FIG. 10. The first resin RS1 may be cured on the second non-pattern part NPG2 to form the second part NFU2 of FIG. 10.

Referring to FIGS. 11C and 11D, a second inkjet head IH2 and second nozzles NOZ2 may be disposed on the pattern glass PG. When viewed on a plane, the second inkjet head IH2 may extend along the first grooves GRU in the second direction DR2. For example, when viewed on a plane, the second inkjet head IH2 may have a rectangular shape.

A plurality of second nozzles NOZ2 may be disposed on a lower surface of the second inkjet head IH2. The second nozzles NOZ2 may be arranged along the first grooves GRU in the second direction DR2. The second nozzles NOZ2 may discharge second resins RS2. The amounts of the second resins RS2 discharged per hour by the respective second nozzles NOZ2 may be equal to each other. The second resin RS2 may include a photocurable material.

For example, the first resin RS1 and the second resin RS2 may include different materials. However, an embodiment of the inventive concept is not limited thereto, and the first and second resins RS1 and RS2 may include the same material.

The second nozzles NOZ2 may discharge the second resins RS2 into the first grooves GRU. The second nozzles NOZ2 may not discharge the second resins RS2 to the first and second non-pattern parts NPG1 and NPG2.

Upper surfaces of the second resins RS2 provided to the first grooves GRU may be higher than the upper surface PG-F of the pattern glass PG. For example, the upper surfaces of the second resins RS2 provided to the first grooves GRU may be higher by about 1 μm to about 3 μm than the upper surface PG-F of the pattern glass PG.

Although not illustrated in the drawing, the second resins RS2 may be cured through ultraviolet rays. The second resins RS2 may be cured to form first filling patterns FL1. When viewed from the second direction DR2, the first filling patterns FL1 may be spaced apart from each other in the first direction DR1.

Since upper surfaces of the first filling patterns FL1 are formed to be higher than the upper surface PG-F of the pattern glass PG, step differences between (3-1)-th and (3-2)-th resins RS3-1 and RS3-2 to be described later and the first filling patterns FL1 may be removed. According to this structure, since the sinkage of the (3-1)-th and (3-2)-th resins RS3-1 and RS3-2 caused by the step differences is prevented, the shapes of the first grooves GRU and the second grooves GRB of the pattern part PGA may be invisible from the outside.

Referring to FIGS. 11E and 11F, a third inkjet head IH3 and third nozzles NOZ3 may be disposed on the pattern glass PG. When viewed on a plane, the third inkjet head IH3 may extend in a second direction DR2. For example, when viewed on a plane, the third inkjet head IH3 may have a rectangular shape.

The third nozzles NOZ3, and fourth nozzles NOZ4 in FIG. 11G, may discharge third resins. The third resins may include the (3-1)-th resin RS3-1 and the (3-2)-th resin RS3-2. Hereinafter, the third resins may be defined as the (3-1)-th and (3-2)-th resins RS3-1 and RS3-2.

The third nozzles NOZ3 may be disposed on a lower surface of the third inkjet head IH3. The third nozzles NOZ3 may be arranged in the second direction DR2. The third nozzles NOZ3 may discharge the (3-1)-th resin RS3-1.

The third nozzles NOZ3 may provide the (3-1)-th resin RS3-1 onto the pattern glass PG. The (3-1)-th resin RS3-1 may be provided onto the pattern part PGA. The (3-1)-th resin RS3-1 may not be provided onto the first and second non-pattern parts NPG1 and NPG2.

The (3-1)-th resin RS3-1 may cover upper surfaces of the first filling patterns FL1 and the pattern part PGA. For example, if the height of an upper surface of the (3-1)-th resin RS3-1 is higher than the height of each of the upper surfaces of the first filling patterns FL1, the thickness from the upper surface PG-F of the pattern glass PG to the upper surface of the (3-1)-th resin RS3-1 may be about 3 m to about m. The height of the (3-1)-th resin RS3-1 may be smaller than the height of each of the first and second parts NFU1 and NFU2.

The (3-1)-th resin RS3-1 may have a flat upper surface. The (3-1)-th resin RS3-1 may provide the flat upper surface by covering the first filling patterns FL1 protruding from the upper surface PG-F of the pattern glass PG.

Referring to FIGS. 11G and 11H, a fourth inkjet head IH4 and fourth nozzles NOZ4 may be disposed on the pattern glass PG. When viewed on a plane, the fourth inkjet head IH4 may extend in a second direction DR2. For example, when viewed on a plane, the fourth inkjet head IH4 may have a rectangular shape.

A plurality of fourth nozzles NOZ4 may be disposed on a lower surface of the fourth inkjet head IH4. The fourth nozzles NOZ4 may be arranged in the second direction DR2. The fourth nozzles NOZ4 may discharge the (3-2)-th resins RS3-2. The amounts of the (3-2)-th resins RS3-2 discharged per hour by the respective fourth nozzles NOZ4 may be equal to each other. The (3-2)-th resin RS3-2 may include a photocurable material.

The fourth nozzles NOZ4 may discharge the (3-2)-th resins RS3-2 onto the pattern part PGA. The fourth nozzles NOZ4 may not discharge the (3-2)-th resins RS3-2 onto the first and second non-pattern parts NPG1 and NPG2.

The (3-2)-th resins RS3-2 may be provided onto the flat upper surface of the (3-1)-th resin RS3-1. The height of an upper surface of the (3-2)-th resins RS3-2 may be same as the height of each of upper surfaces of the first and second parts NFU1 and NFU2.

Referring to FIGS. 11I and 11J, although not illustrated in the drawing, chemical curing and UV curing may be performed on the (3-1)-th and (3-2)-th resins RS3-1 and RS3-2. The (3-1)-th and (3-2)-th resins RS3-1 and RS3-2 may be cured to form an upper pattern layer FU.

For example, the third resin and the first and second resins RS1 and RS2 may include different materials. However, an embodiment of the inventive concept is not limited thereto, and at least two resins of the third resin, the first resin RS1, or the second resin RS2 may include the same material.

Referring to FIGS. 11K, 11L, and 12, the pattern glass PG in FIGS. 11I and 11J may be turned over. The upper surface PG-F of the pattern glass PG may face the stage STG.

The first inkjet head IH1 and first nozzles NOZ1 may be disposed on the pattern glass PG. The first nozzles NOZ1 may discharge first resins RS1 onto a lower surface PG-B of the pattern glass PG. The first nozzles NOZ1 may discharge the first resins RS1 onto lower surfaces of first and second non-pattern parts NPG1 and NPG2. The first nozzles NOZ1 may not discharge the first resins RS1 onto a lower surface of a pattern part PGA.

Although not illustrated in the drawing, the first resins RS1 provided onto the first and second non-pattern parts NPG1 and NPG2 may be cured through chemical curing and UV curing. The first resins RS1 may be cured to form the third and fourth parts NFU3 and NFU4 in FIG. 10. Hereinafter, a method of forming second filling patterns FL2 and a lower pattern layer FB is same as the method of forming the first filling patterns FL1 and the upper pattern layer FU in FIGS. 11C through 11I, and thus the description thereof will be omitted.

Substantially, an upper resin layer SFU and a lower resin layer SFB may be symmetrical to each other in a third direction DR3.

According to an embodiment of the inventive concept, first resins may be provided on a non-pattern part of a pattern glass, in which a plurality of grooves are defined, to form first and second parts, and then second resins may be provided to the first and second grooves to form filling patterns. Upper surfaces of the filling patterns provided to the first grooves may be higher than an upper surface of the pattern glass. Upper surfaces of the filling patterns provided to the second grooves may be more adjacent to a display panel than a lower surface of the pattern glass is. According to this structure, the first and second grooves may be invisible to a user in the outside.

Thereafter, a (3-1)-th resin may be provided onto a pattern part to cover the filling patterns. An upper surface of the pattern part may become flat by the (3-1)-th resin. A (3-2)-th resin may be provided onto a flat upper surface of the (3-1)-th resin. As the (3-1)-th resin is provided to cover the first and second filling patterns, and the (3-2)-th resin is provided to remove step differences from the first and second parts, the surface quality of the pattern glass may be improved.

Although the embodiments of the inventive concept have been described, it is understood that the inventive concept should not be limited to these embodiments but various changes and modifications can be made by one ordinary skilled in the art within the spirit and scope of the inventive concept as hereinafter claimed. In addition, the embodiments disclosed herein are not intended to limit the technical idea of the inventive concept, but all technical ideas within the scope and equivalent of the claims below should be interpreted as being included in the scope of the inventive concept.

What is claimed is:

1. A window manufacturing method comprising:
providing a pattern glass including a first non-pattern part, a pattern part, and a second non-pattern part which are arranged in a first direction;
forming a first part and a second part by providing a first resin onto a first surface of the first non-pattern part and a first surface of the second non-pattern part;
forming first filling patterns by providing second resins to first grooves defined on a first surface of the pattern part; and
forming a first pattern layer by providing a third resin onto the first surface of the pattern part to cover the first filling patterns,
wherein the first filling patterns are spaced apart from each other in the first direction.

2. The window manufacturing method of claim 1, wherein outer surfaces of the first filling patterns are higher than a first surface of the pattern glass.

3. The window manufacturing method of claim 1, wherein the providing of the third resin comprises:
providing a (3-1)-th resin onto the first filling patterns to cover the first filling patterns; and
providing a (3-2)-th resin onto a first surface of the (3-1)-th resin,
the (3-1)-th resin having a flat first surface.

4. The window manufacturing method of claim 3, wherein an outer surface of each of the first filling patterns has a height of about 1 μm to about 3 μm from a first surface of the pattern glass.

5. The window manufacturing method of claim 3, wherein the (3-1)-th resin has a height of about 3 μm to about 5 μm from a first surface of the pattern glass.

6. The window manufacturing method of claim 3, wherein a first surface of the (3-2)-th resin has a same height as first surfaces of the first and second parts.

7. The window manufacturing method of claim 1, wherein the first, second, and third resins comprise different materials from each other.

8. The window manufacturing method of claim 1, wherein at least two resins among the first, second, and third resins comprise a same material.

9. The window manufacturing method of claim 1, wherein when viewed on a plane, the first grooves extend in a second direction crossing the first direction, and are arranged in the first direction.

10. The window manufacturing method of claim 9, wherein the first grooves have a depth larger than a half of a thickness of the pattern glass.

11. The window manufacturing method of claim 1, further comprising:
turning over the pattern glass;
forming a third part and a fourth part by providing the first resin onto second surfaces of the first non-pattern part and the second non-pattern part;
forming second filling patterns by providing the second resins to second grooves defined in a second surface of the pattern part; and
forming a second pattern layer by providing the third resin onto the second surface of the pattern part to cover the second filling patterns,
wherein the second grooves extend in a second direction crossing the first direction.

12. The window manufacturing method of claim 11, wherein a spacing between outer surfaces of the second filling patterns and a first surface of the patterned glass is greater than a spacing between a second surface of the pattern glass and the first surface of the pattern glass.

13. The window manufacturing method of claim 11, wherein the second filling patterns are arranged in the first direction, and
when viewed from the second direction, the second filling patterns and the first filling patterns are alternately arranged in a staggered manner.

14. The window manufacturing method of claim 13, wherein the first filling patterns and the second filling patterns do not overlap each other when viewed from the second direction.

15. A display device comprising:
a display panel;
a pattern glass disposed on the display panel, and including a first non-pattern part, a pattern part, and a second non-pattern part which are arranged in a first direction;
filling patterns disposed in first grooves defined on a first surface and second grooves defined on a second surface of the pattern part;
a first part disposed on a first surface of the first non-pattern part;
a second part disposed on a first surface of the second non-pattern part; and
a first pattern layer disposed between the first part and the second part, and covering the filling patterns,
wherein outer surfaces of the filling patterns protrude from a first surface and a second surface of the pattern glass.

16. The display device of claim 15, wherein the first grooves extend from the first surface of the pattern glass toward the second surface of the pattern glass, and
wherein the second grooves extend from the second surface of the pattern glass toward the first surface of the pattern glass.

17. The display device of claim 16, wherein the filling patterns comprise:
first filling patterns disposed in the first grooves; and
second filling patterns disposed in the second grooves.

18. The display device of claim 17, wherein outer surfaces of the first filling patterns are higher than the first surface of the pattern glass.

19. The display device of claim 17, wherein a spacing between outer surfaces of the second filling patterns and the display panel is less than a spacing between the second surface of the pattern glass and the display panel.

20. The display device of claim 15, further comprising:
a third part disposed on a second surface of the first non-pattern part;
a fourth part disposed on a second surface of the second non-pattern part; and
a second pattern layer disposed between the third part and the fourth part, and covering the second filling patterns.
